(19) United States
(12) Patent Application Publication
(10) Pub. No.: US 2023/0413249 A1
(43) Pub. Date: Dec. 21, 2023

(54) DYNAMIC SWITCHING ALLOCATION BETWEEN FREQUENCY ALLOCATIONS

(71) Applicant: T-Mobile Innovations LLC, Overland Park, KS (US)

(72) Inventors: Nagi A. Mansour, Arlington, VA (US); Akin Ozozlu, McLean, VA (US)

(21) Appl. No.: 17/835,234

(22) Filed: Jun. 8, 2022

(51) Int. Cl. H04W 72/04; H04W 72/08

(52) U.S. Cl. CPC H04W 72/0453; H04W 72/082; H04W 72/048

(57) ABSTRACT

Systems and methods are provided herein to dynamically switch between frequency allocations based on a signal quality measurement of a downlink signal between a user equipment (UE) and a base station. The location of the UE within a cell site can also determine if switching between frequency allocations is needed. One frequency allocation can be used at the edge of a cell and a second frequency allocation can be used near a base station. Either frequency allocation can be used in the middle of a cell site, as needed for congestion handling.

### BACKGROUND

Mobile devices depend on radio frequencies to connect to a mobile network. Cellular carriers lease frequency bands from the Federal Communications Commission and then grant subscribers access to their network. Mobile devices use specific frequencies to communicate with base stations. Carriers have specific frequency allocations within specific bands that their network operates. Congestion can occur in a frequency band near or within a base station and can cause service degradation and dropped calls. Wireless networks can also be affected by interference and noise. Sources of interference and noise can include high traffic volume, high density of cell sites in an area, small cells, inter-cell interference (ICI) at the cell edge, and many others. Subscribers can become frustrated by dropped calls and poor signal quality and network operations risk losing subscribers if the problems are not resolved. The network may have multiple frequency allocations that are used at a base station and congestion can occur on one frequency allocation but not the other. Dynamic switching among a network operator's frequency allocations would allow network operations to improve performance and maximize throughput.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for dynamic switching among frequency allocations. A system includes a base station and a user equipment (UE). The UE includes one or more antennas for receiving downlink signals from the base station and transmitting uplink signals to the base station. The UE includes a processor that is used to determine a first signal quality measurement for a signal quality of the first downlink signal between the base station and the UE. This first signal quality measurement is then compared to a signal quality range. Next, the location of the UE is determined. A current frequency allocation of the UE is also determined. The UE can then be directed to switch to a second frequency allocation from the current frequency allocation based on at least one of the signal quality measurement and the location of the UE.

In a further embodiment, a computer-implemented method for dynamic switching of frequency allocation is provided. The method begins with determining a first signal quality measurement for a signal quality of a downlink signal. Next, a location of a user equipment (UE) is determined. A current frequency allocation of the UE is also determined. The UE may be directed to switch to a second frequency allocation based on at least one of the first signal quality measurement or the location of the UE.

An additional embodiment provides a non-transitory computer storage media storing computer-useable instructions, that when used by one or more processors, cause the processors to determine a first signal quality measurement for a signal quality of a downlink signal. The processors then determine a location of a user equipment (UE) and also determine a current frequency allocation of the UE. Based on at least one of the first signal quality measurement or the location of the UE, the UE can be directed to switch to a second frequency allocation.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 is a flow chart of an exemplary method for dynamically switching between frequency band allocations, in which implementations of the present disclosure may be employed, in accordance with aspects herein;

FIG. 4 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MEM Multiple Input Multiple Output
MD Mobile Device
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 25th Edition (2009).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal The term “modulated data signal” refers to a propagated signal that has one or more of its characteristics set or changed to encode information in the signal. Communications media include any information-delivery media, By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays cannoned by an EnodeB). These transmitting/receiving components together form a multi-sector broadcast arc for communication with mobile handsets linked to the base station.

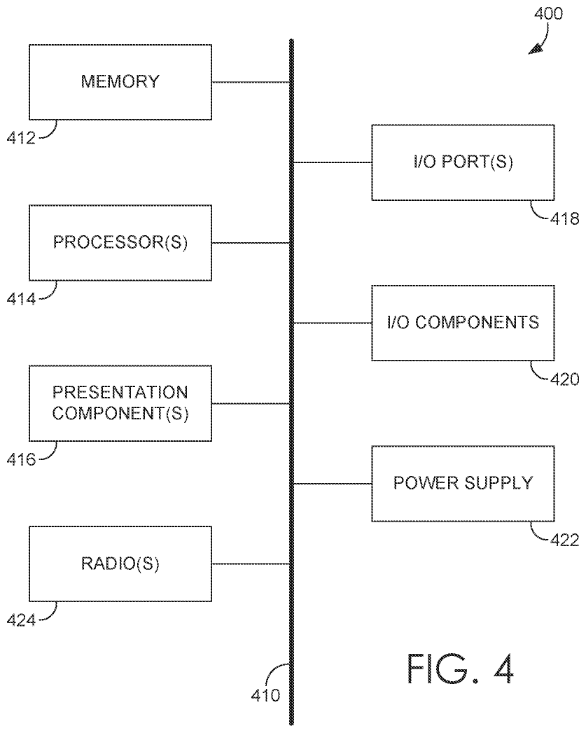

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a LTE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 400 described herein with respect to FIG. 4.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pica cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR) and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

A service state of the UEs may include, for example, an in-service state when a UE is in-network (i.e., using services of a primary provider to which the UE is subscribed to, otherwise referred to as a home network carrier), or when the UE is roaming (i.e., using services of a secondary provider providing coverage to the particular geographic location of the UE that has agreements in place with the primary provider of the UE). The service state of the UE may also include, for example, an emergency only state when the UE is out-of-network and there are no agreements in place between the primary provider of the UE and the secondary provider providing coverage to the current geographic location of the UE. Finally, the service state of the UE may also include, for example, an out of service state when there are no service providers at the particular geographic location of the UE.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the LIE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

In accordance with a first aspect of the present disclosure a system for dynamic switching of frequency allocations is provided. The system includes a base station and a user equipment, the UE comprising one or more antennas. The antennas receive a first downlink signal from the base station and also transmit a first uplink signal to the base station. In addition, the system includes a processor that is configured to determine a first signal quality measurement for the signal quality of a first downlink signal. The processor also determines the first signal quality measurement in relation to a signal quality range. A location of the UE is also determined along with a current frequency allocation of the UE. Based on the first signal quality measurement and the location of the UE, the processor may direct the UE to switch to a second frequency allocation.

A second aspect of the present disclosure provides a computer-implemented method for dynamic switching of frequency allocation. The method includes determining a first signal quality measurement for a signal quality of a downlink signal. The method continues with determining a location of the user equipment (UE) and determining a current frequency allocation of the UE. Based on at least one of the first signal quality measurement and the location of the UE, the UE can be directed to switch to a second frequency allocation.

Another aspect of the present disclosure is directed to a non-transitory computer storage media storing computer-useable instructions that, when used by one or more processors, cause the processors to determine a first signal quality measurement for a signal quality of a downlink signal. The processors also cause the determination of a location of a user equipment (UE) and a current frequency allocation of the UE. The processors also direct the UE to switch to a second frequency allocation based on at least one or the first signal quality measurement or the location of the UE.

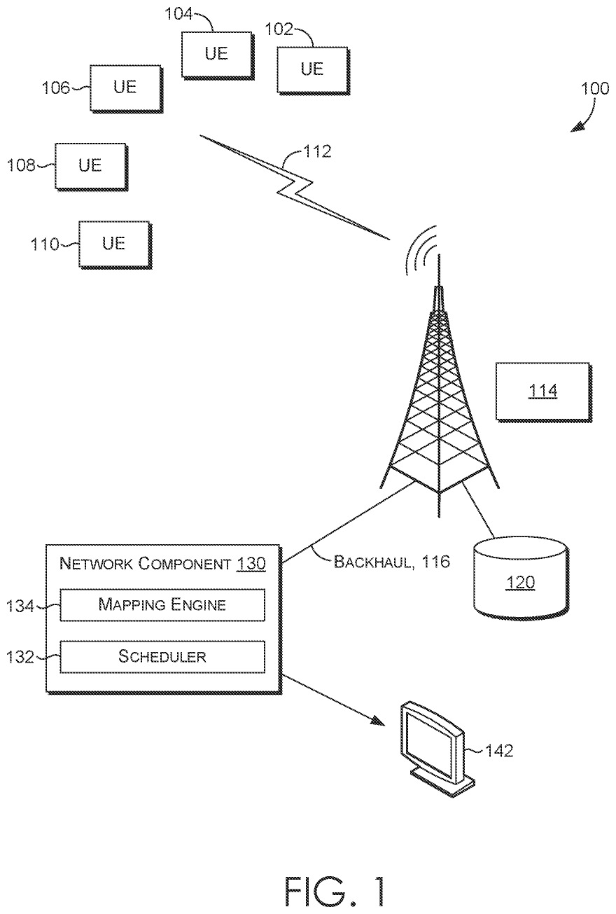

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement

Network environment 100 includes user devices (UE) 102, 104, 106, 108, and 110, access point 114 (which may be a cell site, base station, or the like), and one or more communication channels 112. The communications channels 112 can communicate over frequency bands assigned to the carrier. In network environment 100, user devices may take on a variety of forms, such as a personal computer (PC), a user device, smartphone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 400) that communicates via wireless communications with the access point 114 in order to interact with a public or private network.

In some aspects, each of the UEs 102, 104, 106, 108, and 110 may correspond to computing device 100 in FIG. 1. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114. For example, a carrier can have two frequency bands FR1 and FR2. FR1 can cover 4.1 GHz to 7.125 GHz and FR2 can cover 24.25 (1 Hz to 52.6 GHz. The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1x circuit voice, a 3G network (e.g., CDMA, CDMA2000, WCDMA, GSM, UMTS), a 4G network (WiMAX, LTE, HSDPA), or a 5G network.

In some implementations, access point 114 is configured to communicate with a UE, such as UEs 102, 104, 106, 108, and 110, that are located within the geographic area, or cell, covered by radio antennas of access point 114. Access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices using dynamic beamforming.

As shown, access point 114 is in communication with a network component 130 and at least a network database 120 via a backhaul channel 116. As the UEs 102, 104, 106, 108, and 110 collect individual status data, the status data can be automatically communicated by each of the UEs 102, 104, 106, 108, and 110 to the access point 114. Access point 114 may store the data communicated by the UEs 102, 104, 106, 108, and 110 at a network database 120. Alternatively, the access point 114 may automatically retrieve the status data from the UEs 102, 104, 106, 108, and 110, and similarly store the data in the network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the access point 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a scheduler 132 and a mapping engine 134. All determinations, calculations, and data further generated by the scheduler 132 and the mapping engine 134 may be stored at the data store 140. Although the network component 130 is shown as a single component comprising the scheduler 132 and the mapping engine 134 and the data store 140, it is also contemplated that each of the scheduler 132 and mapping engine 134 may reside at different locations, be its own separate entity, and the like, within the home network carrier system.

The network component 130 is configured to retrieve signal quality metrics from the base station or access point 114 or one of the UEs, 102, 104, 106, 108, and 110. Signal quality metrics can include any one or more of multiple metric, such as SINR. The scheduler 132 and the mapping engine 134 work in conjunction to determine the locations of the UEs 102, 104, 106, 108, and 110 both within the network and within a particular cell site. The base station or access point 114 and the scheduler 132 determine the need for switching between frequency allocations based on location and radio conditions. The allocation of frequency allocations can first be set according to the SINR values and then dynamically adjusted based on location and signal quality.

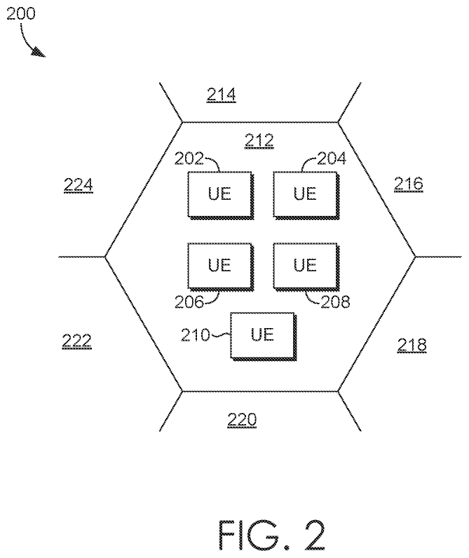

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including base station or access point 114, backhaul channel 116, antenna for sending and receiving signals over communication channels 112, network database 120 and network component 130. The size of the geographic area 400 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell 212 and can move to other cells such as adjoining cells 214, 216, 218, 220, 222 and 224.

Aspects discussed herein provide for dynamic snitching allocation from FR1 to FR 2. UEs, such as UEs 202, 204 206, 208, and 210 can be allocated either FR1 or FR2 based on location and signal quality. For example, FR1 can be used close to the cell edge because it is less lossy than FR2 and offers higher reliability, while FR2 can be used close to the cell site because it provides higher capacity. For the UEs in FIG. 2, UE 210 can be considered near the edge of cell 212 and thus can be assigned FR1. In contrast UEs 206 and 208 can be assigned FR2 as they are close to the cell site. UEs 202 and 204 can be considered as being in the middle of the cell and can be assigned either of FR1 or FR2. In determining whether to assign FR1 or FR2 the scheduler 132 and base station or access point 114 can consider congestion, signal quality, or other measurements.

When considering dynamic switching allocations in the middle of the cell, FRI can be preferred under lossy conditions, because FR1 is less lossy. Signal quality, such as SINR, can also be used to determine which frequency allocation to use. Switching frequency bands can be based on a SINR above the range 10-15 dB, however, other measures of signal quality and radio conditions can be used. In determining whether switching is needed the base station or access point 114 and scheduler 132 can consider location of the UE and radio conditions.

An initial allocation of the dynamic switching allocations within a cell is first set according to the SINR values and is then dynamically adjusted based on the UE's location and signal quality. The signal quality measurements are routinely exchanged between a UE and the current base station. The frequency allocations in the middle of the cell use the SINR values to set the frequency ranges, which can vary by time of day as some times are busier. SINR values can also vary cell to cell and can cause a dynamic reallocation of the frequency range assigned to a UE. As an example, UE 210 is currently in cell 212 and is currently allocated FR1. The UE 210 can move to cell 220 and be located near the base station in cell 220. This can cause a dynamic frequency allocation to UE 210, with the UE 210 directed to change to FR2. During the movement of UE 210 to cell 220 a handover algorithm is used to ensure that an ongoing call is not dropped.

Dynamic switching allocations between frequencies can be based on congestion metrics. Congestion metrics can take into account SINR values, but can also use an algorithm to change frequency ranges with the goal of maximizing throughput. The algorithms used can take into account historical usage of the cell site, when congestion occurs as well as what signal quality values are when congestion occurs.

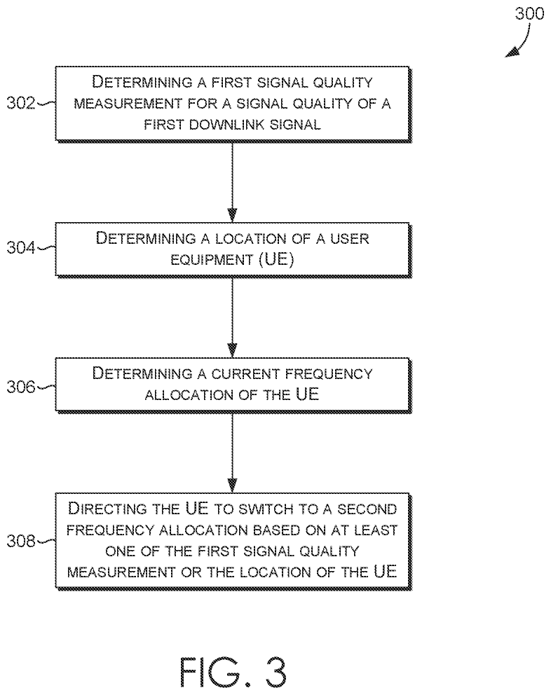

FIG. 3 is a flow chart of an exemplary method for dynamically switching between frequency band allocations, in which implementations of the present disclosure may be employed, in accordance with aspects herein. The method 300 begins in step 302 with determining a first signal quality measurement for a signal quality of a first downlink signal. Signal quality can be measured using any of multiple metrics, however, signal-to-noise and interference (SINR) is common and can be used. The method continues in step 304 with determining a location of a user equipment (UE). The UE can be located within a cell coverage area and within the cell coverage area can be located near and edge of the cell site or near the middle of the cell site. Then, in step 306, a current frequency allocation of the UE is determined. The method concludes in step 308 with directing the UE to switch to a second frequency allocation based on at least one of the first signal quality measurement or the location of the UE. For example, the UE can be directed to switch from a first frequency allocation, FR 1, to a second frequency allocation FR 2 depending on whether the UE has moved from an edge of a cell site to nearer the middle of the cell coverage area.

FIG. 4 depicts an exemplary computing device suitable for use in implementations of the present disclosure, in accordance with aspects herein. With continued reference to FIG. 4, computing device 400 includes bus 402 that directly or indirectly couples the following devices: memory 404, one or more processors 406, one or more presentation components 408, input/output (I/O) ports 412, I/O components 410, radio 416, transmitter 418, and power supply 414. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component such as a display device to be one of I/O components 410. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 400 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and; or nonvolatile memory. Memory 404 may be removable, nonremovable, or a combination thereof. Exemplary memory includes solid-state memory, hard drives, optical-disc drives, etc. Computing device 400 includes one or more processors 106 that read data from various entities such as bus 402, memory 404 or I/O components 410. One or more presentation components 408 present data indications to a person or other device. Exemplary one or more presentation components 408 include a display device, speaker, printing component, vibrating component, etc. I/O ports 412 allow computing device 400 to be logically coupled to other devices including I/O components 410, some of which may be built into computing device 400. Illustrative I/O components 410 include a microphone, joystick, game pad, satellite dish, scanner, printer, wireless device, etc.

The radio 416 represents one or more radios that facilitate communication with a wireless telecommunications network. While a single radio 416 is shown in FIG. 4, it is contemplated that there may be more than one radio 416 coupled to the bus 402. In aspects, the radio 416 utilizes a transmitter 418 to communicate with the wireless telecommunications network. It is expressly conceived that a computing device with more than one radio 416 could facilitate communication with the wireless telecommunications network via both the first transmitter 418 and an additional transmitters (e.g. a second transmitter). Illustrative wireless telecommunications technologies include CDMA, GPRS, TDMA, GSM, and the like. The radio 416 may additionally or alternatively facilitate other types of wireless communications including Wi-Fi, WiMAX, LIE, 3G, 4G, LTE, 5G, NR, VoLTE, or other VoIP communications. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A system for dynamic switching of frequency allocations, the method comprising:
a base station;
a user equipment (UE), the UE comprising one or more antennas for receiving a first downlink signal from the base station and for transmitting a first uplink signal to the base station, and a processor, the processor configure to:
determine a first signal quality measurement for a signal quality of the first downlink signal between the base station and the UE;
determine the first signal quality measurement in relation to a signal quality range;
determine a location of the UE;
determine a current frequency allocation of the UE; and
direct the UE to switch to a second frequency allocation from the current frequency allocation based on at least one of the first signal quality measurement and the location of the UE.

2. The system of claim 1, wherein the first signal quality measurement is based on signal-to-interference and noise (SINR).

3. The system of claim 1, wherein the location of the UE is based on the UE within a coverage area of the cell site.

4. The system of claim 3, wherein the location of the UE within the coverage area of the cell site is one of: near an edge of the cell site or near the middle of the cell site.

5. The system of claim 4, further comprising switching frequency allocations based on the location of the UE changing within the coverage area of the cell site.

6. The system of claim 1, Therein the first frequency allocation (FR 1) differs from the second frequency allocation (FR 2).

7. The system of claim 6, wherein FR 1 is between 4.1 GHz and 7.125 GHz and Therein FR 2 is between 24,25 GHz and 52.6 GHz.

8. The system of claim 6, wherein FR 1 is used an edge of the cell site.

9. The system of claim 6, wherein FR 2 is used near the base station of the cell site.

10. The system of claim 6, wherein either FR 1 or FR 2 is used in the middle of the cell site.

11. The system of claim 10, wherein using either FR 1 or FR 2 is based on the SINR or a congestion metric.

12. A computer-implemented method for dynamic switching of frequency allocation, comprising:
determining a first signal quality measurement for a signal quality of a downlink signal;
determining a location of a user equipment (UE);
determining a current frequency allocation of the UE; and
directing the UE to switch to a second frequency allocation based on at least one of: the first signal quality measurement or the location of the UE.

13. The computer-implemented method of claim 12, wherein the first signal quality measurement is based on signal-to-interference and noise (SINR).

14. The computer-implemented method of claim 12, wherein the location of the UE is based on the LIE within a coverage area or a cell site.

15. The computer-implemented method of claim 14, wherein the location of the UE is one of: near an edge of the cell site or near a middle of the cell site.

16. The computer-implemented method of claim 15, further comprising switching frequency allocations based on the location of the UE changing within the coverage are of the cell site.

17. A non-transitory computer storage media storing computer-useable instructions that, when used by one or more processors, cause the processors to:
determine a first signal quality measurement for a signal quality of a downlink signal;
determine a location of a user equipment (UE);
determine a current frequency allocation of the UE; and
direct the UE to switch to a second frequency allocation based on at least one of the first signal quality measurement or the location of the UE.

18. The non-transitory computer storage media of claim 17, wherein the first signal quality measurement is based on signal-to-interference and noise (SINR).

19. The non-transitory computer storage media of claim 17, wherein the location of the UE is one of: near an edge of a cell site or near a middle of the cell site.

20. The non-transitory computer storage media of claim 19, further comprising switching frequency allocation based on the location of the UE changing within a coverage area of the cell site.
